(19) United States
(12) Patent Application Publication
(10) Pub. No.: US 2003/0184574 A1
(43) Pub. Date: Oct. 2, 2003

(54) Touch screen interface with haptic feedback device

(76) Inventors: James V. Phillips, Vista, CA (US); Blake Hannaford, Seattle, WA (US)

Correspondence Address: NATH & ASSOCIATES PLLC, Sixth Floor, 1030 Fifteenth Street, N.W., Washington, DC, 20005, US

(21) Appl. No.: 10/364,390

(22) Filed: Feb. 12, 2003

Related U.S. Application Data
(60) Provisional application No. 60/357,012, filed on Feb. 12, 2002.

(51) Int. Cl. G09G 5/00

(52) U.S. Cl. 345/702

(57) ABSTRACT

The invention relates to a haptic control device by which an operator is provided with visual as well as tactile feedback. In one embodiment, the operator interacts with a control system via a display panel. Based on the nature of the operator inputs, the control system can provide the operator with both a visual output via the display panel, as well as tactile feedback.

### CROSS REFERENCE TO RELATED APPLICATION

This application claims priority under 35 U.S.C §119(e) to provisional application No. 60/357,012, filed on Feb. 12, 2002.

### FIELD OF THE INVENTION

The present invention relates in general to operator control systems, and in particular to a graphical display interface with an input device and a haptic feedback device which can provide both visual and biomechanical feedback.

### BACKGROUND OF THE INVENTION

Existing aircraft display technologies utilize cathode ray tube (CRT) technology. However, CRT displays are becoming obsolete and suppliers have announced “last time buys” for many CRT components. Furthermore, CRT display technology requires excessive power with extensive weight penalties for aircraft.

In most commercial applications, touch screens provide visual feedback to the operator. However, in certain applications, such as avionics, the physical environment is such that a more robust feedback mechanism is preferable. In particular, pilots or operators in an avionics setting require both visual as well as tactile feedback. Although most touch screen technologies provide visual feedback when activated with an ungloved finger, in some applications the operator must be able to interact with the controls while wearing gloves.

Examples of prior art operator control systems are disclosed in the following patents.

The U.S. Patent to Embach (Pat. No. 4,885,565) discloses an apparatus for providing tactile feedback in response to the touch input command of a user to the touch screen of a Cathode Ray Tube in a CRT command and display system. An actuator is provided that can impart motion to the CRT when the actuator is energized. Energization occurs in response to a touch input command of the user to the touch screen of the CRT. When energized, the actuator provides tactile feedback to the user by imparting motion to the CRT. It is to be noted that this patent does not solve the problems of the bulk, weight and power consumption of the display screen, which is crucial in the case of an operator control system embedded in an avionics environment.

The U.S. patent to Rosenberg et al. (Pat. No. 6,429,846) discloses a haptic feedback planar touch control used to provide input to a computer. A touch input device includes a planar touch surface that inputs a position signal to a processor of the computer based on a location of user contact on the touch surface. The control includes a touch input device including an approximately planar touch surface operative to input a position signal to a processor of said computer based on a location of user contact on the touch surface. The computer positions a cursor in a graphical environment displayed on a display device based at least in part on the position signal. At least one actuator is coupled to the touch input device and outputs a force to provide a haptic sensation to the user contacting the touch surface. The touch input device can be a touchpad separate from the computer's display screen, or can be a touch screen. Output haptic sensations on the touch input device can include pulses, vibrations, and spatial textures.

Each of the foregoing U.S. patents is incorporated herein in its entirety by reference.

Thus, there is a need for a graphical display interface which is lightweight and compact enough to satisfy the stringent requirements of weight and space of an avionics setting and which has low power consumption. There is also a need for a graphical display interface which can provide a touch screen input, and both visual and tactile feedback to a user wearing gloves.

### SUMMARY OF THE INVENTION

The present invention overcomes the shortcomings of the prior art by providing a graphical display interface with an input device and a haptic feedback device which can provide both visual and biomechanical feedback.

The present invention is directed to a haptic feedback touch control used to provide input to a computer system. The control can be a touch screen. Haptic sensations output on the touch control enhance interactions and manipulations in a displayed graphical environment or when controlling an electronic device.

More specifically, the present invention relates to a haptic feedback touch control for inputting signals to a computer and for outputting forces to a user of the touch control. The control includes a touch input device including a touch surface operative to input a signal to a processor of said computer. Said signal is directly defined by an instant location of user contact on the touch surface, independently of the location of any prior user contact on the touch surface, and without any need to reposition any cursor. At least one actuator is coupled to the touch input device and outputs a force on the touch input device to provide a haptic sensation to the user contacting the touch surface. The actuator outputs the force based on force information output by the processor to the actuator.

The touch input device is included in a display screen of the computer as a touch screen. The user contacts the touch surface with a finger, a stylus, or other object. The output force is preferably a linear force output approximately normal to the touch surface of the touch input device. The actuator can include a piezo-electric actuator, a voice coil actuator, a pager motor, a solenoid, or other type of actuator.

The haptic sensations, such as a pulse, or vibration, are output in accordance with an interaction with a graphical object in the graphical environment. For example, a pulse can be output when the user points to a menu element in a menu, selects an icon or executes a command.

In a first particularly preferred embodiment of the invention, the haptic feedback device is screen based. This input and haptic feedback device comprises a transparent plate overlay disposed in front of a flat panel display. This flat panel display can be any type of display not based on cathode-ray tube (CRT) technology, i.e. any non-CRT display. This non-CRT flat panel display can detect a contact and confirm activation of an element displayed at a predefined coordinate location on the flat panel display. When a user makes contact with a point on the display, the location of that point can be determined by receptors in the transparent plate overlay. The receptors are connected to a computer which, in turn, is connected to an amplifier which provides an output signal to a mechanism which generates an impact to the transparent plate. When the user contact is detected at the coordinates corresponding to the predefined coordinate location, the computer signals the amplifier to provide the biomechanical impulse.

In a second particularly preferred embodiment of the invention, the input and haptic feedback device is glove based. This glove is equipped with sensors which can detect and measure several kinds of finger and hand movements, and with stimulators which can generate sensations such as pulses or vibration.

These and other advantages of the present invention will become apparent to those skilled in the art upon a reading of the following specification of the invention and a study of the several figures of the drawing.

### BRIEF DESCRIPTION OF THE DRAWINGS

FIG. 1A is a schematic side elevational view of a system for providing visual and tactile feedback to an operator, according to one embodiment of the present invention.

Figure 1B is a schematic side elevational view of the system of FIG. 1A further including a touch screen input device.

FIG. 1C is a front elevational view of the system of FIG. 1B.

FIG. 2 is a schematic block diagram of a system implementing one embodiment of the invention.

FIG. 3 is a more detailed schematic block diagram of the system of FIG. 2.

FIG. 4 is a schematic block diagram of a computer system which implements one or more embodiments of the invention.

FIG. 5 is a flow chart of a process according to one embodiment of the present invention.

### DETAILED DESCRIPTION OF THE PREFERRED EMBODIMENT

One aspect of the invention is to provide a haptic control device by which an operator is provided with visual as well as tactile feedback. In one embodiment, the operator interacts with a control system via a display panel. Based on the nature of the operator inputs, the control system can provide the operator with visual output via the display panel, as well as tactile feedback. In yet another embodiment, the operator can further be provided with audible feedback.

In one embodiment, the tactile feedback is provided via a transparent plate situated in front of and adjacent to a display panel. One or more actuator mechanisms are oriented such that they apply a physical force against the transparent plate upon activation. This applied force can then be detected/sensed by a user while in contact with the transparent plate, thereby providing tactile feedback to the user.

In another embodiment, a touch screen overlay is attached to a transparent plate. In this embodiment, an operator interacts with the control system by touching various regions of the touch screen. The touch screen can be connected to a processor that captures and processes information corresponding to the contacted regions. The information displayed on a display panel can then be modified to correspond to an input provided by the operator via the touch screen. When the touch screen overlay is positioned in contact with the transparent plate, an actuator mechanism can be activated as the operator contacts the touch screen overlay. Thus, a physical force applied to the transparent plate by the actuator mechanisms can be sensed by the operator as the input to the touch screen is being made.

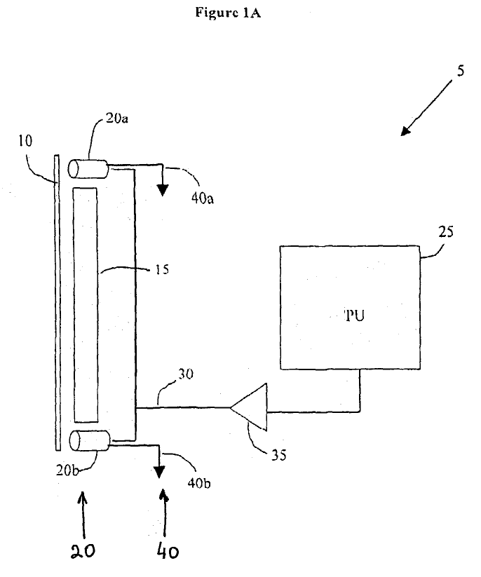

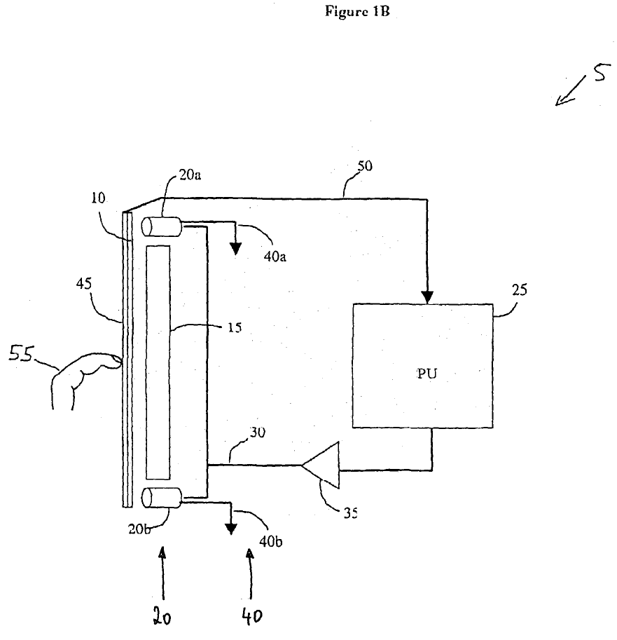

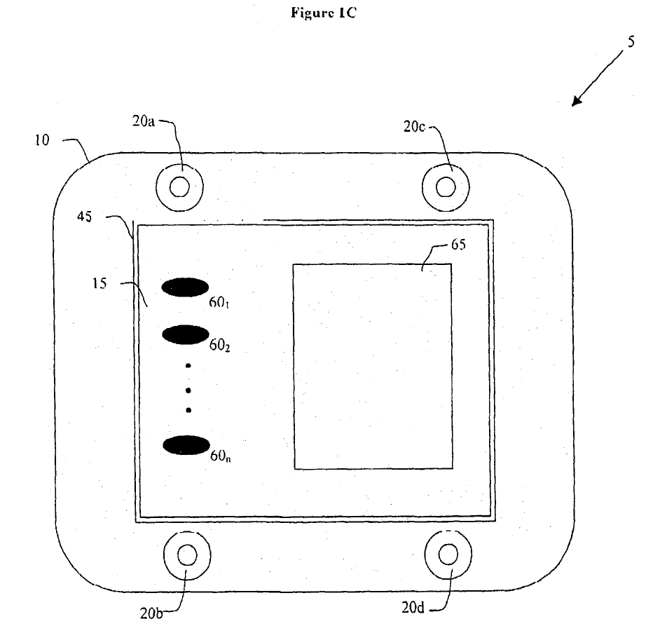

Referring now to FIG. 1A, a diagram of one embodiment of a control system 5 of the invention is depicted. Control system 5 is comprised of plate 10 which is situated in front of display panel 15. Plate 10 can be transparent, translucent, a color filter, or other light permeable panel. In a preferred embodiment display panel 15 is an active matrix liquid crystal display (AMLCD). Other types of non-CRT display panels (display panels not based on cathode-ray tube technology) may be used as well, such as plasma display panels, passive LCD panels, or any other type of non-CRT display panels known to those skilled in the art. Display panel 15 is a 5″×5″ panel in one embodiment, and a 4″×4″ panel in another embodiment. Panels with other dimensions can be used based on the needs of an application.

Actuators 20, such as actuators 20a and 20b depicted in FIG. 1A, are located and oriented to apply a physical force to plate 10 when so directed. In one embodiment, actuators 20 are electromechanical solenoids. However, any mechanism capable of applying a force to plate 10 which would be detectable by an operator in contact with plate 10 can also be used. In an alternate embodiment, feedback is provided by means of one or more piezoelectric devices rather than actuators 20. In a further alternate embodiment, feedback is provided by one or more devices implementing nanotechnology, such as nanomuscles. Such nanomuscles can be made of a material that can expand and/or contract in response to a physical force. In yet another embodiment of the invention, actuators 20 can apply a force directly to an element of a structure coupled to display panel 15, such as a chassis or frame surrounding display panel 15, thereby obviating the need for plate 10.

While FIG. 1A depicts two actuators (20a and 20b), more or fewer actuators can be located at various locations in the proximity of plate 10. In a preferred embodiment four actuators (not shown) are located near the four corners of plate 10. In addition, depending on the relative sizes of display panel 15 and plate 10, the actuators can be located along the sides of display panel 15, as in FIG. 1A, so that they do not obscure any portion of an operator's view of display panel 15.

Alternatively, actuators 20 can be located such that they obscure a portion of the display panel 15. Display panel 15 can be any shape, including circular, elliptical, and any polygon having more or fewer than four sides. For example, display panel 15 can be a triangle-shaped panel. In that case, actuators 20 can be located near each of the three corners of the panel. However, actuators 20 need not be located near the corners of display panel 15, but can be disposed at any location, as long as they can provide detectable haptic feedback to an operator in contact with display panel 15.

In a preferred embodiment, plate 10 is a polycarbonate plate. However, plate can be made of a variety of materials. For example, plate 10 can be made of glass or a rigid plastic material.

Actuators 20 are coupled to a Processing Unit 25 (hereinafter PU 25) over connection line 30. Actuators 20 are connected to a power source (not shown) over connection lines 40 such as lines 40a and 40b depicted in FIG. 1A.

Using the control system 5 of FIG. 1A, an operator can receive visual information from display panel 15, while also receiving tactile feedback from plate 10 as PU 25 activates actuators 20. The visual feedback, which can be provided by software running on PU 25, can provide a user with additional selection options on display panel 15, textual information displayed on display panel 15, or can similarly be provided on a separate display screen (not shown). The feedback provided to the user can also include audible feedback generated by an audio output device such as a speaker (not shown), or can simply be the sound generated by the actuators themselves upon activation and inpact with plate 10.

FIG. 1B depicts another embodiment of control system 5 of FIG. 1A. In this embodiment, touch screen 45 is located adjacent to plate 10 and can even be overlaid on plate 10. Touch screen 45 can utilize any known touch screen technology. Plate 10 and touch screen 45 can be integrated into a single rigid touch-sensitive plate. Touch screen 45 is connected to PU 25 over communication line 50. An operator 55 provides an input to control system 5 by contacting the touch screen 45. A region contacted by operator 55 is detected and processed by PU 25. PU 25 activates actuators 20 to provide haptic feedback to the operator, and can also update/modify the information being displayed on display panel 15. For clarity of the drawings display panel 15 is not shown as being connected to PU 25, but software running on PU 25 can be used to control display panel 15. In one embodiment, PU 25 is a single-board embedded computer system. A memory (not shown) can further be connected to PU 25 and be used to store software executed by PU 25.

FIG. 1C is a front view of the control interface of control system 5, according to a particularly preferred embodiment of the invention. Four actuators 20a-20d (collectively referred to as reference numeral 20) are located adjacent to panel 10. When activated, actuators 20 impact plate 10 in a manner that can be felt by an operator in contact with plate 10. Although four actuators 20 are depicted in FIG. 1C, more or fewer actuators can be used. In addition, the actuators can be situated such that, when activated, they accelerate toward plate 10 and impact plate 10 with a given velocity. Alternatively, actuators 20 can be situated such that they are in constant contact with plate 10 and push and displace plate 10 when activated. FIG. 1C further depicts touch screen 45 as being overlaid onto display panel 15. In FIG. IC touch screen 45 is depicted as larger than display panel 15, but touch screen 45 can also be the same size or smaller than display panel 15 without departing from the principles and the spirit of the invention.

FIG. 1C further depicts a number of displayed elements on display panel 15. In particular, buttons 60, individually numbered 60₁-60_{N}, and information region 65 are shown as being displayed by display panel 15. Displayed elements can also include buttons, keys, text, graphics, sliders, arrows, pull-down menus, graphics with active elements, functional icons, or any other displayable element. An operator can provide input to control system 5 by selecting one of the displayed elements (e.g., any button 60) by contacting a portion of touch screen 45 corresponding to a region containing the desired element. As will be described in more detail below, the operator can then be provided with feedback corresponding to the particular element selected.

The feedback provided can be haptic feedback provided by activating actuators 20. The feedback provided can also include audible feedback and visual feedback, where the information and selection options displayed on display panel 15 are altered or updated depending on the nature of the operator's input. Software running on PU 25 can be used to process operator's inputs and provide feedback to the operator by activating actuators 20 and/or by providing an audible signal and/or updating/modifying the elements displayed on display panel 15. Operator's inputs and corresponding feedback signals can also be provided by one or more separate processors (not shown) in communication with PU 25.

The location, size and number of buttons 60 depicted in FIG. 1C is provided by way of example only. Any number of buttons, having varying shapes and arrangements, can similarly be used. Similarly, the method used by the operator to provide input to control system 5 can be by selecting displayed buttons, or the operator can also provide an input by contacting a specific region of touch screen 45, or a series of regions, the selected region corresponding to one or more displayed elements having predefined functionalities. The operator input is then processed by associating the region of touch screen 45 contacted with a predefined functionality associated with a particular displayed element assigned to that region. This association function can be performed by software running on PU 25. Certain elements displayed on display panel 15 may also not be intended to be selectable. For example, information region 65 can be used by control system 5 to provide information, either textual or graphical, to the operator. The content in information region 65 can change based on operator inputs or, alternatively, as a function of other criteria. As with any displayed element, information region 65 can have any shape, size and appear in any number of occurrences on display panel 15.

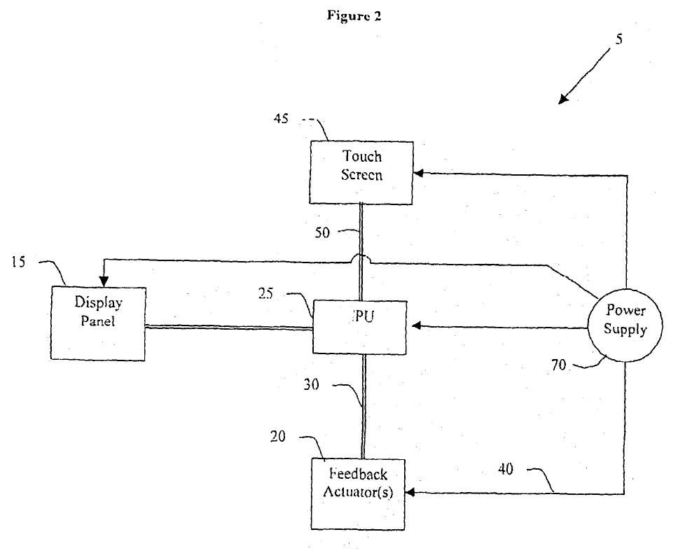

FIG. 2 is a simplified schematic of control system 5 implementing one embodiment of the invention. In FIG. 2, display panel 15, touch screen 45, feedback actuators 20 and PU 25 are all provided power via a common power supply 70. However, more than one power supply can be used to power one or more of these elements.

FIG. 2 also depicts PU 25 as being coupled to touch screen 45, display panel 15 and feedback actuators 20. PU 25 controls and coordinates these separate elements. Software running on PU 25 can control the information displayed on display panel 15 as a function of an input that an operator provides to touch screen 45. Similarly, PU 25 can use touch screen 45 to detect when an operator is in contact with the transparent plate so that feedback actuators 20 can be activated to provide tactile feedback to the operator. In an alternate embodiment, feedback to the operator is provided using one or more piezoelectric devices. In further embodiments, other types of feedback mechanisms known to those skilled in the art can be used.

The force applied by actuators 20 to plate 10 can be adjusted depending on what level of feedback is desired. For example, the magnitude of the haptic feedback sensation can be increased by increasing the amount of force the actuators 20 apply to the plate 10. In one embodiment, this level of force is adjustable using software running on PU 25. In addition, the timing of the actuator activation can be adjusted so as to provide operator 55 with near instant feedback or, alternatively, with delayed feedback.

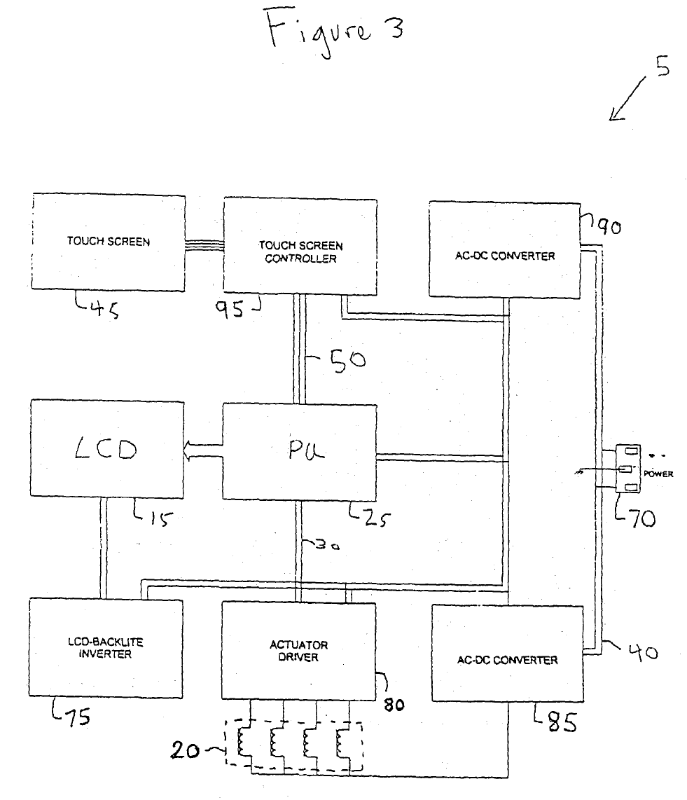

FIG. 3 is a more detailed schematic of one embodiment of the control system 5 of FIG. 2. In the embodiment depicted, panel 15 is an LCD screen. In another embodiment, the LCD screen can be a flat panel, thin-film transistor LCD. An LCD-backlite inverter 75 can be used to supply power to LCD 15 from power supply 70. Different types of power supply can be used depending on the installation requirements of a particular application.

As depicted in FIG. 3, actuators 20 are coupled to an actuator driver 80. AC/DC converters 85 and 90 are connected to AC power supply 70 and are used to provide DC power to actuators 20, PU 25, touch screen controller 95, and actuator driver 80. In this embodiment, touch screen 45 is coupled to and controlled by PU 25 through touch screen controller 95.

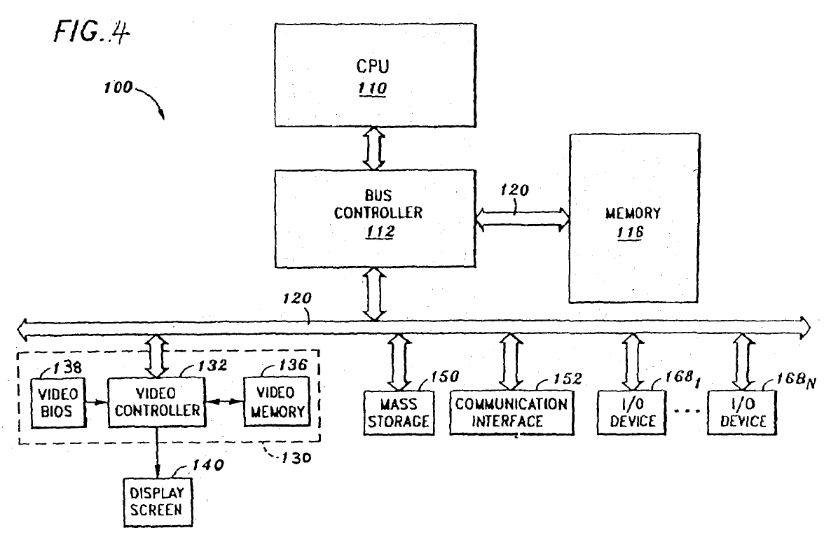

PU 25 is a processor-based computer system, such as computer system 100 of FIG. 4, where a Central Processing Unit (CPU) 110 includes an Arithmetic Logic Unit (ALU) for performing computations, a collection of registers for temporary storage of data and instructions, and a control unit for controlling operation of computer system 100. CPU 110 is not limited to microprocessors but can take on other forms such as microcontrollers, digital signal processors, reduced instruction set computers (RISC), application specific integrated circuits, and the like. Although shown with one CPU 110, computer system 100 can alternatively include multiple central processing units.

CPU 110 is coupled to a bus controller 112. Bus controller 112 includes a memory controller (not shown) integrated therein. This memory controller can also be external to bus controller 112. The memory controller provides an interface for access to memory 116 by CPU 110 or other devices. System memory 116 can be a Synchronous Dynamic Random Access Memory (SDRAM) and more particularly can include single data rate SDRAM (SDR SDRAM), double data rate SDRAM (DDR SDRAM) and reduced latency DRAM (RLDRAM), or include any additional or alternative high speed memory device or memory circuitry as known by those skilled in the art. Bus controller 112 is coupled to a system bus 120, which can be a peripheral component interconnect (PCI) bus, an Industry Standard Architecture (ISA) bus, or other conventional or proprietary bus architecture.

Computer system 100 can also include optional visual display components 130. Visual display components 130 include a graphics engine or a video controller 132. Video controller 132 can be coupled to a video memory 136 and a video Basic Input/Output System (BIOS) 138. Video memory 136 contains display data for displaying information on an optional display screen 140, and video BIOS 138 includes code and video services for controlling the video controller 132. Video controller 132 can also be coupled to CPU 110 through an Advanced Graphics Port (AGP) bus (not shown).

Computer system 100 can further include an optional mass storage device 150 connected to system bus 120. Optional mass storage device 150 can include (but is not limited to) a hard disc, floppy disc, CD-ROM, CD-R, CD-RW, DVD, CDRW-ROM, DVDRW-ROM, tape, high density floppy, high capacity removable media, low capacity removable media, solid state memory device, or other memory device known to those skilled in the art, and combinations thereof. A communication interface device 152 can include a network interface, a modem interface, a radio frequency (RF) transceiver, an Infra-Red (IR) transceiver or other communication interface known to those skilled in the art, for accessing other devices.

Computer system 100 can also include one or more input/output (I/O) devices 168₁-168_{N} connected to system bus 120. I/O devices 168₁-168_{N} can include any conventional Input/Output device such as a keyboard, an audio card, instrumentation drivers, and/or other I/O devices known to those skilled in the art. The software that processes operator inputs and provides information via display panel 15 can be stored on memory 116, mass storage 150 or can be received over communication interface 152 and/or from I/O devices 168₁-168_{N}.

In another embodiment, PU 25 can be implemented as a single board embedded computer. In such an embodiment, optional display components 130, optional display screen 140, I/O devices 168₁-168_{N}, and optional mass storage 150 need not be included.

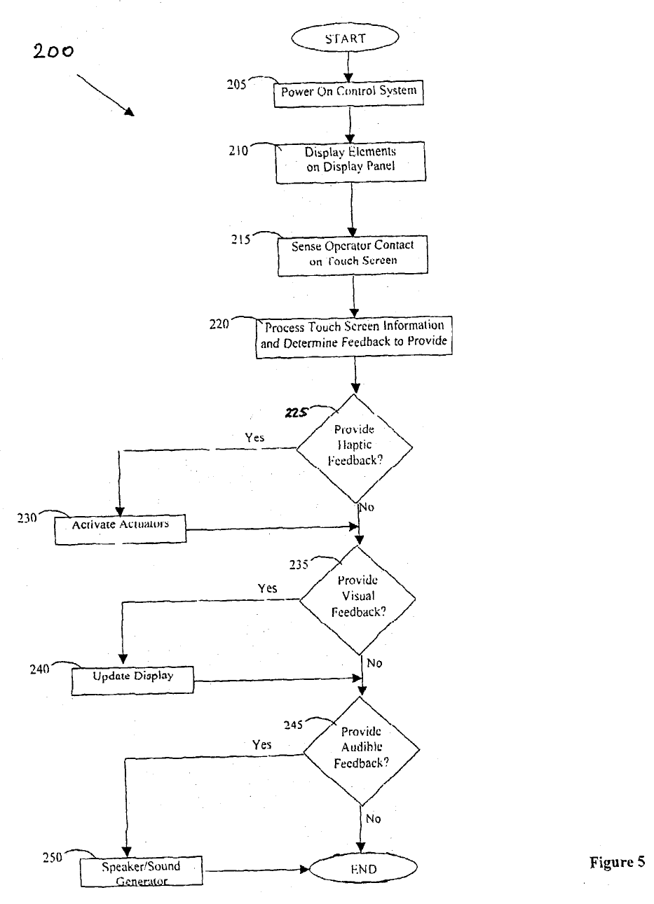

Referring now to FIG. 5, a process 200 of implementing one aspect of the invention is depicted as a flow chart. Process 200 begins at block 205, where control system 5 is powered on. Control system 5 can be powered on in conjunction with other systems or, alternatively, can be powered on individually. Thereafter, at block 210 one or more elements are displayed on display panel 15 where, as discussed above, the elements can include configurable function keys, textual information or any other graphical information. Software running on PU 25 provides the data needed for display panel 15 to display the elements. The elements to be displayed may correspond to a particular application in which control system 5 is being implemented.

Process 200 then proceeds to block 215 once an operator contacts the touch screen 45 (as depicted in FIG. 1B). An operator contact is detected, and a signal is generated and sent to a processing function. To avoid false “touches,” the sensitivity of touch screen 45 can be adjusted so that an operator input requires a greater or lesser amount of pressure. Similarly, the sensitivity of touch screen 45 can be increased to more easily detect operator inputs.

At block 220, the processing function processes the operator input and determines the nature, if any, of the feedback to provide to the operator. This processing function can be performed by software running on PU 25, or by a separate processing system. The processing function determines if the region of touch screen 45 contacted corresponds to a displayed element on display screen 15 by comparing coordinates received from touch screen 45 with sets of predetermined coordinates. In a preferred embodiment of the invention, a displayed element corresponds to a region of touch screen 45 when at least a portion of the region of the touch screen 45 overlays the displayed element. Where the region of touch screen 45 does have a corresponding displayed element, the selected displayed element may further have an associated function. The associated function is performed by software executed by PU 25 or by another processing system.

Process 200 then executes decision block 225, where a determination is made as to whether the operator is to be provided with haptic feedback. If so, process 200 branches to block 230 where PU 25 provides a signal to activate actuators 20. The activation of actuators 20 coincides with the operator's contact of the overlaid touch screen 45, thereby enabling the operator to experience tactile feedback to the input just made. Process 200 then executes a decision block 235 either after the activation of the actuators 20 or right after decision block 225 if the outcome of decision block is negative and no haptic feedback is to be supplied.

Process 200 then branches to a decision block 235, where a determination is made as to whether visual feedback is to be provided to the operator. If so, process 200 moves to block 240 where the elements displayed on display panel 15 are updated and/or modified. The color and/or brightness of the selected element can be altered to indicate that it has been selected. The elements on display panel 15 can also be altered in any fashion to provide visual feedback to the operator. FIG. 5 depicts the haptic feedback of block 230 and the visual feedback of block 240 are shown in sequence, for clarity purposes only. However, in one or more embodiments of the present invention, the haptic feedback of block 230 and the visual feedback of block 240 can also be provided simultaneously.

Process 200 then executes decision block 245, where a determination is made as to whether audible feedback is to be provided. In one embodiment, the operator is provided with audible feedback in the form of the sound caused by the activation of actuators 20. This sound can be caused by the force applied to plate 10 by actuators 20, or can be caused by the actuator mechanism itself. Alternatively, it may be desirable to provide an additional form of audible feedback. For example, a speaker or other sound generator can be coupled to control system 5 for this purpose. In such an embodiment, the sound generator mechanism, which can be any known sound generator mechanism, is activated at block 250. In addition, where more than one of the haptic feedback of block 230, the visual feedback of 240 and the audible feedback of block 250 is to be provided in response to the operator input, the feedbacks can be provided simultaneously (not shown) or consecutively (as depicted in FIG. 5).

One aspect of the invention is to provide a control system suitable for avionics applications. The bezel interface of a cockpit can be modified to implement a touch screen interface according to the present invention. Conventional avionics displays are usually integrated into a bezel with pushbutton switches or have separate control panels with pushbuttons. The present invention can me be used to provide a tactile feedback response system on a touch screen that is similar to the tactile response provided by conventional pushbutton switches. The touch screen can replace the existing mechanical bezels and can consist of a transparent, non-reflective overlay. The touch screen can provide an operator, such as a pilot, with visual feedback when selecting a “switch” displayed on the display panel. In one embodiment, the touch screen can be utilized for the same functions as switch bezels, such as selection in menu navigation, ordinance selection, communication commands, map selection and manipulations, etc.

As discussed above, tactile feedback can also be provided to the operator via a combination of the transparent plate 10 and the actuator(s) 20. The force applied to the plate 10 by the actuator(s) 20 can be calibrated to provide a sensation similar to what a pilot can be used to from a conventional control system, according to one embodiment. In other embodiments, piezoelectric devices can be used in place of actuator(s) 20 to provide the desired sensation to the pilot.

When the invention is implemented in a avionics application, the display can provide the same configuration as that provided by a conventional bezel interface in the same kind of aircraft, thereby limiting the time necessary for the learning and adaptation process.

Although only a few exemplary embodiments of the present invention have been described above, it will be appreciated by those skilled in the art that many changes may be made to these embodiments without departing from the principles and the spirit of the invention.

What is claimed is:

1. A graphical display interface with an input and a haptic output that provides both visual and biomechanical feedback, comprising:
a non-CRT display panel;
an overlay disposed in front of said display panel, that can detect contact by a user at a position corresponding to an image displayed at a predefined coordinate location on said display panel;
a tactile output device coupled to said overlay; and
a computer connected to said overlay and to said tactile output device, said computer being adapted to receive an input information from said overlay, to analyze said input information according to a predetermined program and to provide a corresponding output information to said tactile output device to impart a biomechanical feedback sensation when the user contact is detected at coordinates corresponding to the predefined coordinate location, wherein said predetermined program analyzes said input information and provides said output information independently of a cursor on the display panel.

2. The graphical display interface of claim 1 further comprising a memory, said memory having instruction sequences of said predetermined program stored thereon that determine if the user contact occurs in a predetermined region of said overlay.

3. The graphical display interface of claim 2, wherein said instruction sequences cause an actuator to apply a force to said overlay during at least a portion of time that the user contact occurs.

4. The graphical display interface of claim 1, wherein said tactile output device comprises at least one actuator that applies a force to the overlay.

5. The graphical display interface of claim 1, wherein said overlay and said display panel are integrally connected parts of a single rigid touch-sensitive plate.

6. The graphical display interface of claim 1 further comprising a memory, said memory further having instruction sequences of said predefined program stored thereon that display a visual element in a predetermined region of said display panel, said predetermined region of said display panel corresponding to a predetermined region of said overlay.

7. The graphical display interface of claim 6, wherein said instruction sequences provide the user with a visual feedback which includes alteration of an appearance of an element displayed on the display panel.

8. The graphical display interface of claim 7, wherein the memory further includes instruction sequences that alter information displayed on the display panel based on the user contact.

9. The graphical display interface of claim 1 further comprising an amplifier connected to said computer and said tactile output device.

10. The graphical display interface of claim 9 wherein a magnitude of an output of said amplifier is controlled by said computer to control a magnitude of the biomechanical feedback sensation.

11. A graphical display interface with an input and a haptic output that provides both visual and biomechanical feedback, comprising:
a non-CRT display panel that can detect contact by a user at a position corresponding to an image displayed at a predefined coordinate location on said display panel;
a tactile output device coupled to said display panel; and
a computer connected to said display panel and to said tactile output device, said computer being adapted to receive an input information from said display panel, to analyze said information according to a predetermined program and to provide a corresponding output information to said tactile output device to impart a biomechanical feedback sensation when the user contact is detected at coordinates corresponding to the predefined coordinate location, wherein said predetermined program analyzes said input information and provides said output information independently of a cursor on the display panel.

12. The graphical display interface of claim 11 further comprising a memory, said memory having instruction sequences of said predetermined program stored thereon that determine if the user contact occurs in a predetermined region of said display panel.

13. The graphical display interface of claim 12, wherein said instruction sequences cause an actuator to apply a force that can be perceived on said display panel during at least a portion of time that the user contact occurs.

14. The graphical display interface of claim 11, wherein said tactile output device comprises at least one actuator that applies a force that can be perceived on said display panel.

15. The graphical display interface of claim 11 further comprising a memory, said memory further having instruction sequences of said predefined program stored thereon that display a visual element in a predetermined region of said display panel.

16. The graphical display interface of claim 15, wherein said instruction sequences provide the user with a visual feedback which includes alteration of an appearance of an element displayed on the display panel.

17. The graphical display interface of claim 11 further comprising an amplifier connected to said computer and said tactile output device.

18. The graphical display interface of claim 17, wherein said amplifier is controlled by said computer to control a magnitude of the biomechanical feedback sensation.

19. A method of providing both visual and biomechanical feedback through a graphical display interface with an input and a haptic output, the method comprising the steps of:
providing a non-CRT display panel;
providing an overlay disposed in front of said display panel, that can detect contact by a user at a position corresponding to an image displayed at a predefined coordinate location on said display panel;
providing a tactile output device coupled to said overlay; and a computer connected to said overlay and to said tactile output device, wherein said computer receives an input information from said overlay, analyzes said information according to a predetermined program independently of a cursor on the display panel, and provides a corresponding output information to said tactile output device to impart a biomechanical feedback sensation when the user contact is detected at coordinates corresponding to the predefined coordinate location.

20. The method of claim 19 further comprising the step of providing an amplifier connected to said computer and said tactile output device, said amplifier controlling a magnitude of the biomechanical feedback sensation.
